(19) United States
(12) Patent Application Publication
(10) Pub. No.: US 2004/0153872 A1
(43) Pub. Date: Aug. 5, 2004

(54) System and method for multi-destination delivery

(75) Inventor: Tamio Okui, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/640,003

(22) Filed: Aug. 14, 2003

(30) Foreign Application Priority Data
Aug. 27, 2002 (JP) 2002-247799

(51) Int. Cl. H02H 3/05

(52) U.S. Cl. 714/47

(57) ABSTRACT

A system and method for multi-destination delivery which ensure data delivery efficiency of a certain level. A talker delivers data to a plurality of listeners. The data retransmission request section of each listener analyzes the received data to detect erroneous data and missing data, and sends a data retransmission request to the data retransmission control section of the talker. The talker retransmits the data to the listener in response to the data retransmission request. The line monitoring section of the listener monitors line status, and provides the listener line status aggregating section of the talker with the result of the monitoring. Consequently, the talker is made aware of the line status of the listener in substantially real time. The data retransmission control section eliminates a “problematic listener” from the destinations to which data are to be delivered based on circumstances. Accordingly, it is possible to ensure the quality of data delivery.

### FIELD OF THE INVENTION

The present invention relates to a system and method for multi-destination delivery, more particularly, to a system and method for multi-destination delivery which are aimed at improving data delivery efficiency.

### BACKGROUND OF THE INVENTION

Generally, multi-destination delivery has been carried out by one-way non-procedural lines. Besides, there is a demand for a reliable data delivery system for various reasons and, in order to improve the reliability of multi-destination delivery, the receipt of data is acknowledged after data delivery in recent years.

As an example of the prior art in a similar technical field, Japanese Patent Application laid open No. HEI2-90831 discloses “broadcast control system”. According to the prior art, a parent station eliminates a child station, which has become impossible to receive data due to a deterioration of line quality during transmission, from its objects of communication or correspondent stations. Before retransmitting data to the child station, the parent station transmits a link setting frame including a list of eliminated child stations. Meanwhile, child stations notify the parent station about their line status on a regular basis. Consequently, the parent station can execute efficient retransmission, and is always aware of the line status of the child stations.

In the above-mentioned prior art system, however, non-procedural data delivery is conducted as in the past, and there is no mechanism to recover delivery with a little data error. Consequently, a significant drop in delivery efficiency is inevitable.

Although there have been proposed a variety of methods using one-many type bidirectional protocols for data delivery, a satisfactory throughput cannot be achieved since line qualities differ much among existent listeners (recipients in multi-destination delivery).

Additionally, in the prior art system, a decision as to whether delivery is possible or not is made based only on the state of data reception within the system. Namely, there is a basic problem in the prior art in that it has not established the method of using the state of receipt of data sent from other talkers (originating or sending stations in multi-destination delivery) as information for making decisions on the line quality.

### SUMMARY OF THE INVENTION

It is therefore an object of the present invention to provide a multi-destination delivery system and multi-destination delivery method for securing data delivery efficiency at a certain level.

In accordance with the first aspect of the present invention, to achieve the above object, there is provided a multi-destination delivery system comprising a talker that delivers prescribed data and a plurality of listeners that receive the data, wherein: each listener includes a data retransmission request section for detecting a data error and a data loss in received data and requesting the talker for retransmission; the talker includes a data retransmission control section for retransmitting data in response to a retransmission request from the data retransmission request section of each listener; and a retransmission request line is established for sending the retransmission request.

In accordance with the second aspect of the present invention, there is provided a multi-destination delivery system comprising a talker that delivers prescribed data and a plurality of listeners that receive the data, wherein: each listener includes a data retransmission request section for detecting a data error and a data loss in received data and requesting the talker for retransmission, and a line monitoring section for monitoring line status to notify the talker of the line status; the talker includes a listener line status aggregating section for aggregating information on the state of data reception and line status given by the line monitoring section of each listener, and a data retransmission control section for retransmitting data in response to a retransmission request from the data retransmission request section of each listener based on the output of the listener line status aggregating section; and the retransmission is controlled based on the monitored line status to secure desired data delivery efficiency.

In accordance with the third aspect of the present invention, in the first or second aspect, the talker may select destination listeners according to the line status of the respective listeners. That is, the talker may eliminate one or more listeners from the destinations to which data are to be delivered according to the line status of the respective listeners if necessary.

In accordance with the fourth aspect of the present invention, there is provided a multi-destination delivery method in a multi-destination delivery system including a talker that delivers prescribed data and a plurality of listeners that receive the data, comprising: a detecting step in which each listener detects a data error and a data loss in received data and sends a retransmission request to the talker via a retransmission request line; and a retransmitting step in which the talker retransmits data in response to the retransmission request.

In accordance with the fifth aspect of the present invention, there is provided a multi-destination delivery method in a multi-destination delivery system including a talker that delivers prescribed data and a plurality of listeners that receive the data, comprising: a detecting step in which each listener detects a data error and a data loss in received data and sends a retransmission request to the talker; a line monitoring step in which each listener monitors line status to notify the talker of the line status; a listener line status aggregating step in which the talker aggregates information on the state of data reception and line status given by the listeners as a result of their monitoring of the line status; and a retransmitting step in which the talker retransmits data in response to the retransmission request from each listener based on the information obtained in the listener line status aggregating step; wherein the retransmission is controlled according to the monitored line status to secure desired data delivery efficiency.

In accordance with the sixth aspect of the present invention, in the fourth or fifth aspect, the talker may select destination listeners according to the line status of the respective listeners.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing the configuration of a multi-destination delivery system according to the first embodiment of the present invention; and

FIG. 2 is a block diagram showing the configuration of a multi-destination delivery system according to the second embodiment of the present invention.

### DESCRIPTION OF THE PREFERRED EMBODIMENTS

Referring now to the drawings, a description of preferred embodiments of the present invention will be given in detail.

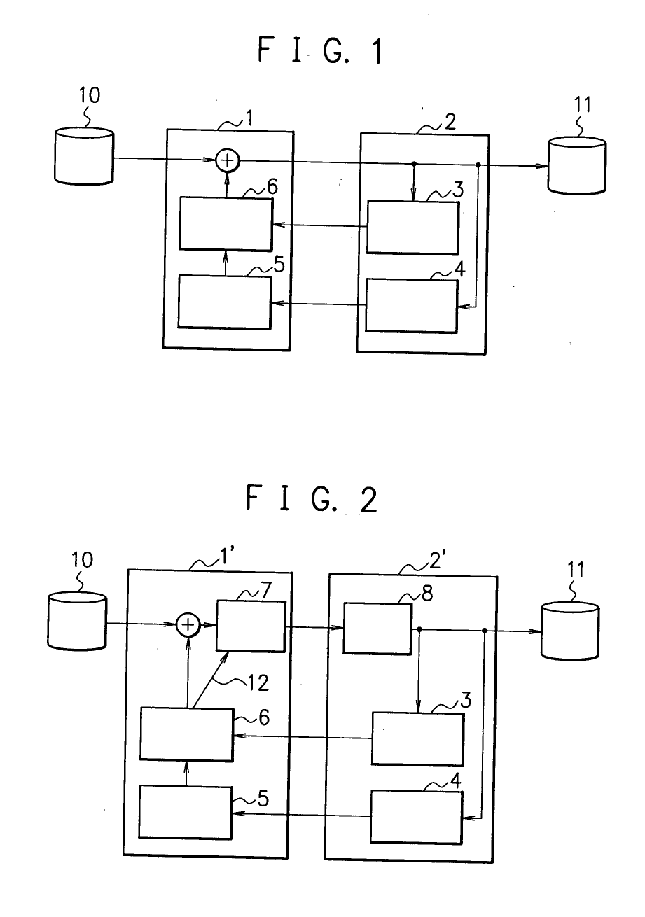

FIG. 1 is a block diagram showing the configuration of a multi-destination delivery system according to the first embodiment of the present invention. Referring to FIG. 1, the multi-destination delivery system comprises a talker 1, a plurality of listeners 2, only one of which being shown, transmission data 10 and receive data 11. The talker 1 is an originating or sending station, and delivers data to the listeners 2 simultaneously. The talker 1 includes a listener line status aggregating section 5 and a data retransmission control section 6. On the other hand, the listener 2 is a recipient, and receives data sent from the talker 1. The listener 2 includes a data retransmission request section 3 and a line monitoring section 4.

The data retransmission request section 3 detects a data error and a data loss in received data, and requests the talker for retransmission.

The line monitoring section 4 monitors line status or line quality, and provides the talker 1 with the result of the monitoring so that the talker 1 can keep track of the line status or line quality of the listener 2.

The listener line status aggregating section 5 aggregates information on the state of data reception and line status given by the line monitoring section 4 of the listener 2.

The data retransmission control section 6 retransmits data in response to a data retransmission request from the data retransmission request section 3 based on the output of the listener line status aggregating section 5. More specifically, the data retransmission control section 6 checks the line quality of the listener 2 based on information about the state of receipt of data sent from other talkers to the listener 2, physical line status such as electrical synchronization information, etc. in addition to the state of receipt of data sent from the talker 1. When the data retransmission control section 6 determines that the line of the listener 2 is in a poor state or quality, the control section 6 eliminates the listener 2 as a “problematic listener” from the destinations to which data are to be delivered. Besides, even if the listener 2 has received data retransmitted from the talker 1 normally, when data retransmission requests from the listener 2 are so frequent as to affect the overall delivery performance, the data retransmission control section 6 regards the listener 2 as a “problematic listener”, and eliminates it from the destinations.

In the following, a description will be given of the operation of the multi-destination delivery system according to the first embodiment of the present invention.

First, the talker 1 sends data to plural listeners all at once. Upon receiving the data, the data retransmission request section 3 of each listener 2 analyzes the received data to detect erroneous data and missing data (data that have failed to reach the listener 2). When finding out such data, the data retransmission request section 3 sends a data retransmission request to the data retransmission control section 6 of the talker 1 via a retransmission request line. The talker 1 retransmits the data to the listener 2 in response to the data retransmission request.

Incidentally, one problem that is encountered in the retransmission is that of the amount of traffic required to retransmit the data. If the line of any one of the plural listeners is in a very poor state, the data retransmission requests transmitted from the listener increase retransmission and line traffic, thus causing congestion.

Accordingly, in a data delivery system, it is necessary to eliminate such “problematic listener” from the destinations to which data are to be delivered for improving data delivery efficiency to thereby maintain the quality of data delivery above a certain level.

With this in view, according to the present invention, the line monitoring section 4 of the listener 2 monitors line status, and provides the listener line status aggregating section 5 of the talker 1 with the result of the monitoring. Consequently, the talker 1 is made aware of the line status or quality of the listener 2 in substantially real time. When the data retransmission control section 6 has judged the listener 2 as a “problematic listener” from the output of the listener line status aggregating section 5, the talker 1 eliminates the listener 2 from the destinations to which data are to be delivered. Thus, it is possible to ensure the quality of data delivery.

In the following, a description will be given of a multi-destination delivery system according to the second embodiment of the present invention.

FIG. 2 is a block diagram showing the configuration of a multi-destination delivery system according to the second embodiment of the present invention. Referring to FIG. 2, the multi-destination delivery system of the second embodiment comprises a talker 1′, a plurality of listeners 2′, only one of which is seen in the drawing, a transmission data 10 and a receive data 11.

The listener 2′ includes a data retransmission request section 3 for detecting a data error and a data loss in received data and requesting the talker 1′ for retransmission, a line monitoring section 4 for monitoring line status to notify the talker 1′ of the line status, and a decryption section 8.

On the other hand, the talker 1′ includes a listener line status aggregating section 5 for aggregating information on the state of data reception and line status given by the line monitoring section 4 of each listener 2′, a data retransmission control section 6 for retransmitting data in response to a retransmission request from the data retransmission request section 3 of each listener 2′ based on the output of the listener line status aggregating section 5, and a data encryption section 7.

Incidentally, the multi-destination delivery system shown in FIG. 2 is basically similar to that of FIG. 1 except for the data encryption section 7 and decryption section 8, and similar numbers are utilized in designating corresponding sections of the system. In addition, the data retransmission request section 3, line monitoring section 4, listener line status aggregating section 5 and data retransmission control section 6 operate in much the same manner as described previously for the first embodiment, and therefore do not require any further explanation.

In the second embodiment, the talker 1′ and listener 2′ are provided with the data encryption section 7 and decryption section 8, respectively, so that the listener which has been eliminated from destinations cannot receive data. In the case of pay or fee-charging data delivery, data is generally encrypted to allow listeners conditional access to the data. According to this embodiment, the data encryption section 7 is fed with eliminated listener information 12 obtained by the data retransmission control section 6, and encrypts data to limit access to the data to the listeners 2′ other than eliminated listeners based on the eliminated listener information 12.

As set forth hereinabove, in accordance with the present invention, a talker (transmitting end) checks the line status or quality of respective listeners (receiving end) sequentially to control the amount of traffic caused by retransmission. In other words, a talker selects its listeners and limits access to data to the selected listeners based on the line status of all the listeners. Consequently, it is possible to reduce line traffic due to retransmission and maintain data delivery efficiency above a certain level.

Moreover, in accordance with the present invention, the talker judges the line quality of the listeners not only by the state of receipt of data sent from the talker itself but also the state of receipt of data sent from other talkers to the listeners, physical line status, and the like. Thus, the talker can control properly the amount of traffic caused by retransmission.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A multi-destination delivery system comprising a talker that delivers prescribed data and a plurality of listeners that receive the data, wherein:
each listener includes a data retransmission request section for detecting a data error and a data loss in received data and requesting the talker for retransmission; and
the talker includes a data retransmission control section for retransmitting data in response to a retransmission request from the data retransmission request section of each listener.

2. A multi-destination delivery system comprising a talker that delivers prescribed data and a plurality of listeners that receive the data, wherein:
each listener includes a data retransmission request section for detecting a data error and a data loss in received data and requesting the talker for retransmission, and a line monitoring section for monitoring line status to notify the talker of the line status;
the talker includes a listener line status aggregating section for aggregating information on the state of data reception and line status given by the line monitoring section of each listener, and a data retransmission control section for retransmitting data in response to a retransmission request from the data retransmission request section of each listener based on the output of the listener line status aggregating section; and
the retransmission is controlled based on the monitored line status to secure desired data delivery efficiency.

3. The multi-destination delivery system claimed in claim 1, the talker selectively delivers data to the listeners according to the line status of the respective listeners.

4. The multi-destination delivery system claimed in claim 2, the talker selectively delivers data to the listeners according to the line status of the respective listeners.

5. A multi-destination delivery method in a multi-destination delivery system including a talker that delivers prescribed data and a plurality of listeners that receive the data, comprising:
a detecting step in which each listener detects a data error and a data loss in received data and sends a retransmission request to the talker; and
a retransmitting step in which the talker retransmits data in response to the retransmission request.

6. A multi-destination delivery method in a multi-destination delivery system including a talker that delivers prescribed data and a plurality of listeners that receive the data, comprising:
a detecting step in which each listener detects a data error and a data loss in received data and sends a retransmission request to the talker;
a line monitoring step in which each listener monitors line status to notify the talker of the line status;
a listener line status aggregating step in which the talker aggregates information on the state of data reception and line status given by the listeners as a result of their monitoring of the line status; and
a retransmitting step in which the talker retransmits data in response to the retransmission request from each listener based on the information obtained in the listener line status aggregating step; wherein:
the retransmission is controlled according to the monitored line status to secure desired data delivery efficiency.

7. The multi-destination delivery method claimed in claim 5, the talker selectively delivers data to the listeners according to the line status of the respective listeners.

8. The multi-destination delivery method claimed in claim 6, the talker selectively delivers data to the listeners according to the line status of the respective listeners.
